(19) United States
(12) Patent Application Publication
(10) Pub. No.: US 2005/0285363 A1
(43) Pub. Date: Dec. 29, 2005

(54) Roller sled and roller ski using the same

(76) Inventors: Woo Kyung Joung, Kimpo City (KR); Chun Sik Ham, Koyang City (KR)

Correspondence Address: CHERYL H AGRIS PHD, PO BOX 806, PELHAM, NY, 10803, US

(21) Appl. No.: 10/878,449

(22) Filed: Jun. 28, 2004

(51) Int. Cl. B62M 1/00

(52) U.S. Cl. 280/87.041; 280/842

(57) ABSTRACT

Disclosed is a novel roller sled or roller ski. One may ride a mono-sled on the ice or ski on the snow, they can enjoy a riding play on an asphalt road, a concrete-paved road or a level ground.

### FIELD OF THE INVENTION

The present invention relates, in general, to a roller sled and roller ski and methods of using the same which people of all ages and both sexes can enjoy. In particular, the method relates to a roller sled and roller ski in which two or more rollers are mounted to a panel of a certain size in a row. One may use the roller sled and roller ski on an asphalt road, a concrete paved road or a level ground.

### BACKGROUND OF THE INVENTION

A conventional roller sled has two or more rollers in a row and a blade in the middle of the panel so that it can be used on the ice. The roller sled was published on Sep. 25, 2002 for Korean utility model registration no. 233965 and it comprises “a roller sled with shafted rollers; wherein a main frame is provided on the lower surface of a step panel with holes formed on the main frame and two or more rollers are shafted to the holes of the main frame with bearings; and a break pad made of the material having a frictional force and small abrasive property is mounted slopingly on a lower surface of a rear part of the step panel”, and “a conventional stick with a handle detachably assembled; wherein a moving pin having a pin head of which diameter is bigger than that of the body is formed and the sharp portion of it is projected downwardly, and the pin head is inserted to a slide slot of a lower part and elastically biased by a spring”. The conventional roller sled and stick can be used easily on a concrete-paved open space and road, or an asphalt concrete-paved open space and road in addition to the ice. When riding the roller sled, the roller sled is accelerated with a pair of sticks while standing on the roller sled with balance. The conventional roller sled has two rollers in the middle of the step panel having a main frame, an outer frame, a roller cover and pad housing.

The conventional sled has a number of drawbacks. It takes a lot of skill for a user to be able to easily maintain balance and ride on, e.g., a the concrete-paved road. Secondly, if the sled leans to one side when riding with two rollers, the one side end of the step panel comes into contact with the surface of the road and is damaged. As a result, safety accidents may happen. Thirdly, when riding the sled, a user may easily slip on an upper surface of the step panel. In addition, it is difficult to recognize the conventional roller sled at night and traffic accidents may happen.

### OBJECTS OF THE INVENTION

It is an object of the present invention to provide a roller sled, in which sub-wheels are detachably mounted on both sides of a lower surface of the step panel and where a user who may be an unskilled person, may maintain the balance more easily when riding it. If the user doesn't need the sub-wheels, he may separate them from the step panel and ride the roller sled with only rollers.

It is another object of the present invention to provide a roller sled, in which the rollers are luminous rollers that emit light during rotation so that it is easy to recognize the roller sled at night, and form slots on a roller cover.

It is another object of the present invention to provide a roller sled where there is no concern that the user's shoes slip and that the roller sled stops promptly when the step panel leans to one side while the user is riding it and prevents safety accidents from occuring.

It is another object of the present invention to provide a roller ski using roller sled, in which the user's feet are placed on it as the conventional ski and the user can enjoy the roller ski in a place which doesn't have snow.

### SUMMARY OF THE INVENTION

The invention is directed to a roller sled, comprising a main frame on the lower surface of a step panel with holes formed on the main frame and two or more rollers shafted to the holes of the main frame with bearings; a break pad made of material having a frictional force and small abrasive property, wherein said pad is mounted slopingly to a pad housing of the lower surface of a control unit provided on the rear part of the step panel wherein said rollers are luminous rollers that emit light from inner lamps during a rotation thereof and wherein a plurality of emitting slots are formed on a roller cover which is projected upwardly on the step panel and covers the rollers.

Furthermore, the invention is directed to a riding device with shafted rollers comprising a roller ski comprising a roller sled, in comprising main frames on the lower surface of step panels with holes formed on the main frames and two or more rollers shafted to the holes of the main frames with bearings; and fastening units on the middle upper surface between the rollers so that both of user's shoes are placed respectively on the step panels.

### BRIEF DESCRIPTION OF THE FIGURES

The above and other objects, features and other advantages of the present invention will be more clearly understood from the following detailed description when taken in conjunction with the accompanying drawings, in which:

FIG. 1 is a perspective view illustrating a roller sled in accordance with an embodiment of the present invention.

FIG. 2 is a plan view in accordance with an embodiment of the present invention.

FIG. 3 is a side view in accordance with an embodiment of the present invention.

FIG. 4 is a bottom view in accordance with an embodiment of the present invention.

FIG. 5 is a side view illustrating a roller sled in accordance with another embodiment of the present invention.

FIG. 6 is a bottom view in accordance with another embodiment of the present invention.

FIG. 7 is a side view illustrating a using state of a roller sled in accordance with another embodiment of the present invention, when it stops.

FIG. 8 is a front view in accordance with another embodiment of the present invention.

FIG. 9 is a side view illustrating a roller ski of the present invention in use.

FIG. 10 is a plan view illustrating a roller ski of the present invention in use.

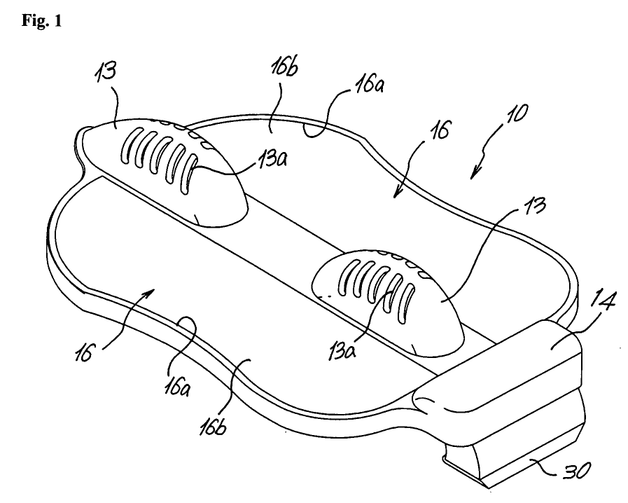

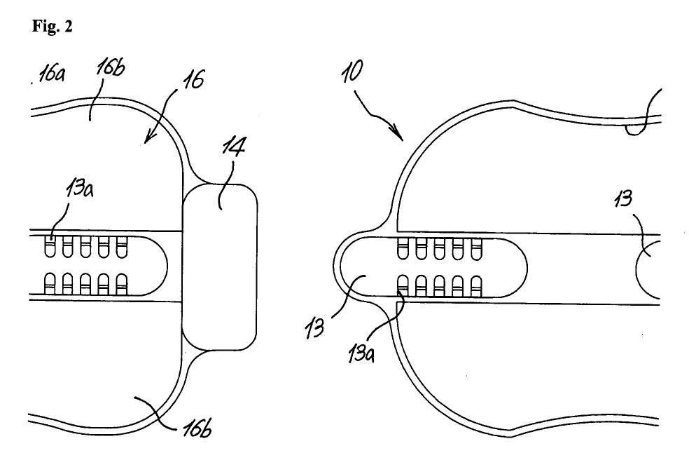

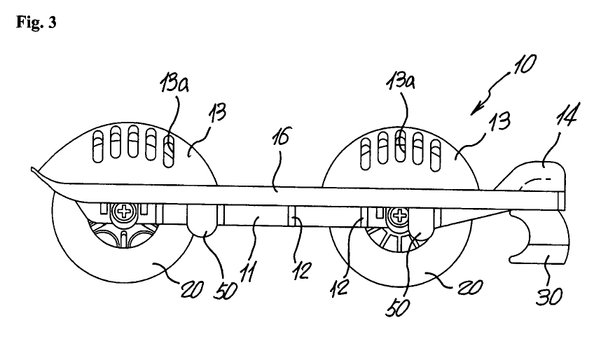

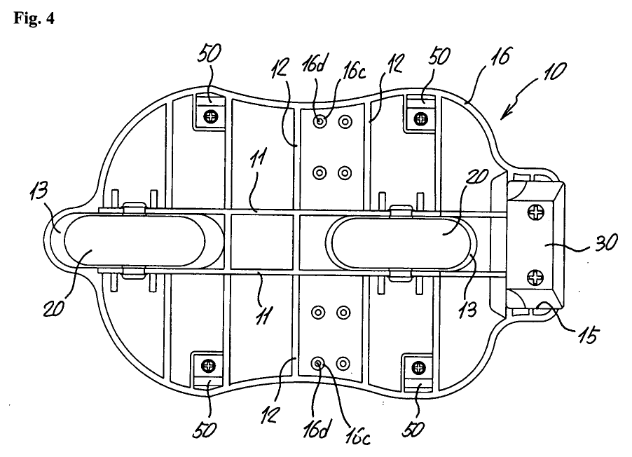

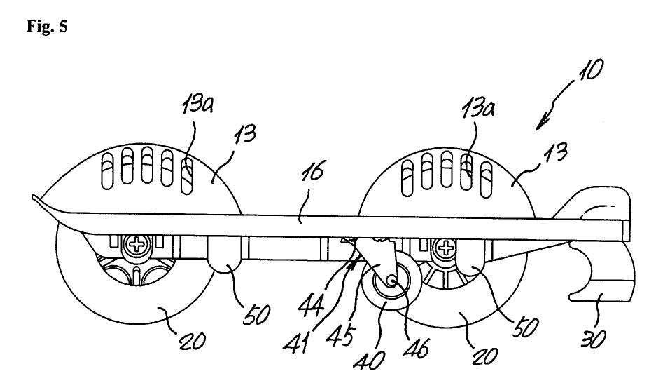

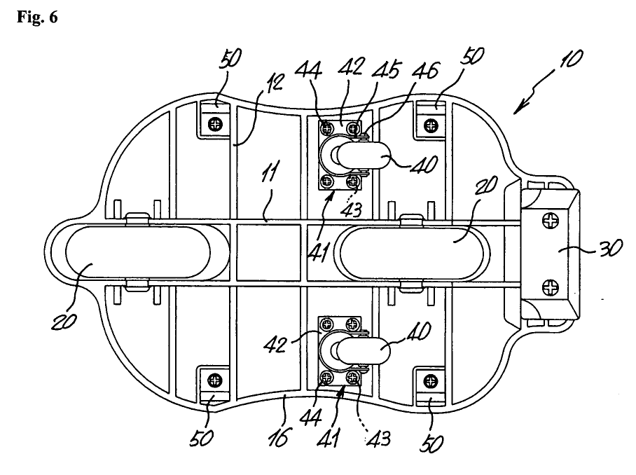

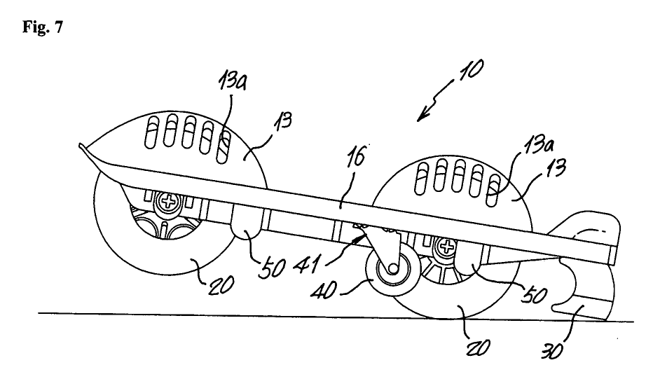

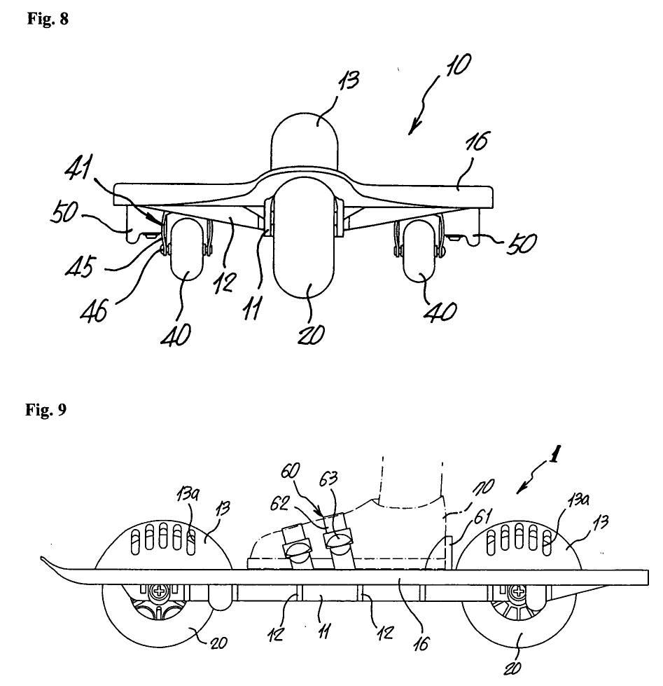

### DETAILED DESCRIPTION OF THE INVENTION

Based on the present invention, the above objects can be accomplished by a provision of a roller sled, in which a main frame is provided on the lower surface of a step panel with holes formed on the main frame and two or more rollers are shafted to the holes of the main frame with bearings; a break pad made of material having a frictional force and small abrasive , said pad is mounted slopingly to a pad housing of the lower surface of a control unit provided on the rear part of the step panel; wherein said rollers are luminous rollers that emit light from inner lamps during a rotation thereof; and wherein a plurality of emitting slots are formed on a roller cover which is projected upwardly on the step panel and covers the rollers.

A depression may be formed inwardly on the upper surface of the step panel and an antislip sheet having a strong frictional force like a rubber is attached to the depression.

The control unit is provided on both sides of the rear part of the step panel and break pads are inserted and mounted respectively to pad housings of the control unit provided on both sides.

Bosses having a plurality of locking slots are provided on each of both sides of a lower surface of the step panel and sub-wheels rotating freely are shafted to the bosses by sub-wheel brackets.

The sub-wheels are located more highly than lower ends of the rollers so that the step panel may easily rotate in a direction of rotation when changing the course.

The sub-wheel brackets comprise mounting panels having locking holes aligned with and mounted to the locking slots of the bosses by setscrews, wheel covers, in which their upper ends are shafted to the mounting panels and its lower ends extend downwardly to cover the sub-wheels, and locking rivets shafting the sub-wheels on both sides of lower ends of the wheel covers.

Side break pads made of the material having a frictional force and small abrasive property and projected downwardly in length of 20-50 mm are mounted on front and rear parts of the lower surface of the step panel so that the lower end of the step panel may not be in contact with the ground surface toward which the step panel leans when the step panel rotates.

### EXAMPLE

A roller sled 10 according to the present invention comprises a main frame 11 which is provided on the lower surface of the step panel 16 with holes formed on the main frame 11. Two or more rollers 20, which are luminous rollers that emit light from inner lamps during a rotation thereof, are shafted to the holes of the main frame 11 with bearings. A break pad 30 made of the material having an excellent frictional force and a small abrasive property is mounted on the lower surface of the rear part of the step panel 16. A plurality of emitting slots 13a are formed on a roller cover 13 which is projected upwardly on the step panel 16 and covers the rollers 20. A depression 16a is formed inwardly on an upper surface of the step panel 16 and an antislip sheet 16b having a strong frictional force like a rubber is attached to the depression 16a. Bosses 16c having a plurality of locking slots 16d are provided on each of both sides of a lower surface of the step panel 16 and sub-wheels 40 rotating freely are shafted to the bosses 16c by sub-wheel brackets 41.

The sub-wheels 40 are located more highly than lower ends of the rollers 20 so that the step panel 16 may rotate easily in a direction of rotation when changing the course of making a turn.

The sub-wheel brackets 41 comprise mounting panels 42 having locking holes 43 aligned with and mounted to the locking slots 16d of the bosses 16c by setscrews 44, wheel covers 45, in which its upper ends are shafted to the mounting panels 42 and its lower ends extend downwardly to cover the sub-wheels 40, and locking rivets 46 shafting the sub-wheels 40 on both sides of lower ends of the wheel covers 45.

The break pads 30 made of the material having a frictional force, small abrasive property and projected downwardly in length of 20-50 mm are mounted on front and rear parts of the lower surface of the step panel 16. The side break pads 30 are used for protecting the step panel 16 so that the lower end of the step panel 16 may not be in contact with the ground surface toward which the step panel 16 leans when rotating.

The roller sled 10 of the present invention has a number of uses. When a user rides the roller sled 10 according to the present invention, sticks of which lower ends are made of rubber for safety may be provided to accelerate the roller sled 10 while standing on the roller sled 10 with balance. The user holds the sticks with both hands, places the roller 20 of the roller sled 10 toward the ground, and then puts one foot on the step panel 16.

The user may put his right foot on a right side of the step panel 16 or may put his left foot on a left side of the step panel 16. Balance may be maintained by using sticks with both hands. Force is added to the sticks as the user pushes his body forward.

The roller sled 10 carrying weight maintains the balance by the centrifugal force when the rollers 20 start rolling and by a strong and quick poling motion of the user. The user may gradually accelerate the roller sled 10 and enjoy riding it even on the level ground. When attempting to stop, i.e., in case that user wants to reduce speed or stop while riding the roller sled 10, the user may place his heels on the control unit 14, pull his hip backwards and compress the control unit 14 by the heels while raising the front parts of the feet. As a result, a front part of the roller sled 10 is elevated and simultaneously a rear part of comes down. Therefore, the break pads of a lower surface of the control unit 14 come into contact with the ground and by the degree of friction, the roller sled 10 may be decelerated or stopped safely.

Meanwhile, as the break pads 30 are inserted partially inside a pad housing 15 of the control unit 14, when applying the brake, the pad housing 15 strongly grasps the brake pads 30 so that the brake pads 30 support much force and simultaneously disperse the frictional force. Accordingly the pad housing 15 prevents the break pads 30 from breaking or being damaged.

The control unit 14 may be provided on both sides of the rear part of the step panel 16 and the break pads 30 are inserted and mounted respectively to pad housings 15 of the control unit 14 provided on both sides.

Since the user needs a lot of exercising to maintain the balance and ride the roller sled 10 on the level ground, the user may use the roller sled 10, in which sub-wheels 40 are mounted on each of both sides of the lower surface of the step panel 16. Here, locking holes 43 are aligned with the mounting panels 42 on the sub-wheel brackets 41 and mounted to the locking slots 16d of the bosses 16c projected on lower both sides of the step panel 16 with setscrews 44.

The sub-wheels 40 having the sub-wheel brackets 41 rotatably shafted on each of both sides of a lower surface of the step panel 16 supports the user who is an unskilled person easily losing balance.

If with the sub-wheels 40, the user continuously repeats balancing on the upper surface of the step panel 16, leans to one side when stopping or riding the roller sled 10 slowly forward, he may easily ride the roller sled 10 without the sub-wheels 40.

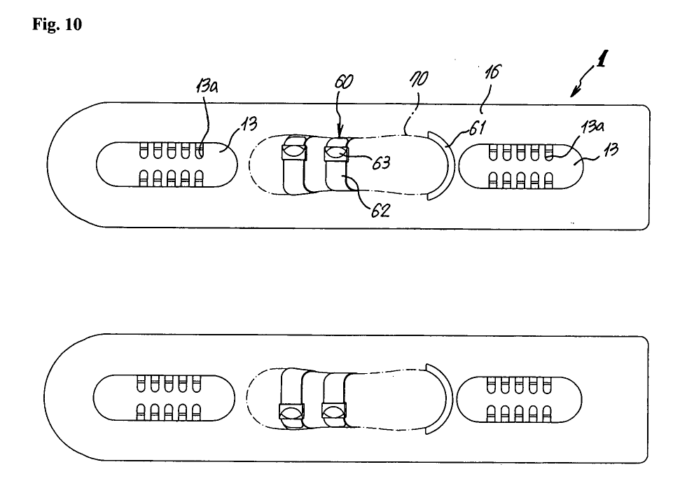

FIG. 9 is a side view illustrating the use of a roller ski 1 of the present invention and FIG. 10 is a plan view illustrating a using state of a roller ski 1 of the present invention.

The roller ski 1 using the roller sled 10 of the present invention is a riding device with a pair of shafted rollers 20. Main frames 11 are provided on the lower surface of step panels 16 with holes formed on the main frames 11 and two or more rollers 20 are shafted to the holes of the main frames 11 with bearings. Fastening units 60 are provided on the middle upper surface between the rollers 20 so both of the user's shoes are placed respectively on the step panels 16.

The fastening units 60 comprise a heel support 61 mounted on the upper surface of the step panel and contacted with the heels of the user's shoes and at least one fastening band 62, in which its both sides are mounted in front of the heel support 61 and fastened by buckles 63 so that the user's shoes may be placed on the upper surface of the step panel 16.

The rollers 20 are luminous rollers 20 that emit light from inner lamps during a rotation thereof and a plurality of emitting slots 13a formed on a roller cover.

As apparent from the above description, the roller ski 1 using the roller sled 10 is formed with the space between a front roller 20 and a rear roller 20. It is desirable that the width of the roller ski 1 is formed narrowly and the length of the roller ski 1 is formed longer than the width, but it may be constructed to have a shorter length.

Shoes 70 are fastened with at least one fastening band 62. The heels of the shoes 70 are placed on the step panel 16 to be in contact with the heel supports 61 on a central upper surface of the step panel 16. The user then fastens the fastening band 62 by the buckles 63 mounted to one end of the fastening band 62, holds sticks to which slip preventing members are mounted with both hands, pushes them backwards. Accordingly the user may move forward with the roller ski 1 and use the ski on the level ground.

Also, if the user wants to stop while riding, while he makes the front parts of both roller skis 1 close inwardly or leans the step panel 16 to one side so that the center of gravity moves to one side, he may stop riding the roller ski 1 by the frictional force between the roller 20 and the ground.

As apparent from the above description, the roller sled and roller ski using the same according to the present invention provides a number of advantages. The user who is an unskilled person may maintain the balance and easily ride the roller sled and roller ski by the sub-wheels or ride them without the sub-wheels. It is easy to recognize the roller sled and the roller ski when riding them at night. The shoes of the user don't slip. Even though the step panel leans to one side, it may be stopped promptly, therefore, the safety accidents may be prevented. The roller sled and roller ski of the present invention provides another advantage in that both of the user's shoes may be placed respectively on a pair of roller skis.

Thus, the user can enjoy them everywhere and it makes adults feel nostalgia of their childhood and it provides children and teenagers with promotion of their health and sound playing culture.

While the invention has been shown and described with reference to a certain preferred embodiment thereof, it will be understood by those skilled in the art that various changes in form and details may be made therein without departing from the spirit and scope of the invention as defined by the appended claims.

Various references are cited herein, the disclosures of which are incorporated by reference in their entireties.

1. A roller sled, comprising a main frame on the lower surface of a step panel with holes formed on the main frame and two or more rollers shafted to the holes of the main frame with bearings; a break pad made of material having a frictional force and small abrasive property, wherein said pad is mounted slopingly to a pad housing of the lower surface of a control unit provided on the rear part of the step panel;
wherein said rollers are luminous rollers that emit light from inner lamps during a rotation thereof; and
wherein a plurality of emitting slots are formed on a roller cover which is projected upwardly on the step panel and covers the rollers.

2. The roller sled of claim 1, wherein a depression is formed inwardly on an upper surface of the step panel and an antislip sheet having a strong frictional force like a rubber is attached to the depression.

3. The roller sled of claim 1, wherein the control unit is provided on both sides of the rear part of the step panel and break pads are inserted and mounted respectively to pad housings of the control unit provided on both sides.

4. The roller sled of claim 1, wherein bosses having a plurality of locking slots are provided on each of both sides of the lower surface of the step panel and sub-wheels rotating freely are shafted to the bosses by sub-wheel brackets.

5. The roller sled of claim 1, wherein the sub-wheels are higher than lower ends of the rollers so that the step panel may easily rotate in a direction of rotation when changing course.

6. The roller sled of claim 1, wherein the sub-wheel brackets comprise (a) mounting panels having locking holes aligned with and mounted to the locking slots of the bosses by setscrews;, (b) wheel covers, in which its upper ends are shafted to the mounting panels and its lower ends extend downwardly to cover the sub-wheels, and (c)locking rivets shafting the sub-wheels on both sides of lower ends of the wheel covers.

7. The roller sled of claim 1, wherein side break pads made of the material having a frictional force and small abrasive property and projected downwardly in length of 20-50 mm are mounted on front and rear parts of the lower surface of the step panel so that the lower end of the step panel may not be in contact with the ground surface toward which the step panel leans when the step panel rotates.

8. A riding device with shafted rollers comprising
a roller ski comprising a roller sled, in comprising main frames on the lower surface of step panels with holes formed on the main frames and two or more rollers shafted to the holes of the main frames with bearings; and
fastening units on the middle upper surface between the rollers so that both of user's shoes are placed respectively on the step panels.

9. The roller ski of claim 8, wherein the fastening units comprise a heel support mounted on an upper surface of the step panel and contacted with the heels of the user's shoes and at least one fastening band, in which both sides are mounted in front of the heel support and fastened by buckles so that the user's shoes may be placed on the upper surface of the step panel.

10. The roller ski of claim 8, wherein the rollers are luminous rollers to emit light from inner lamps during a rotation thereof and a plurality of emitting slots are formed on a roller cover.
